(19) United States
(12) Patent Application Publication
(10) Pub. No.: US 2025/0267487 A1
(43) Pub. Date: Aug. 21, 2025

(54) METHOD FOR DYNAMIC RF DATALINK NETWORK MODELING AND MISSION EVALUATION

(71) Applicant: Rockwell Collins, Inc., Cedar Rapids, IA (US)

(72) Inventor: Christopher Routh, Marion, IA (US)

(21) Appl. No.: 18/582,229

(22) Filed: Feb. 20, 2024

(51) Int. Cl. H04W 24/10; H04B 17/391

(52) U.S. Cl. CPC H04W 24/10; H04B 17/391

(57) ABSTRACT

A network modeling system which includes an RF synthetic environment controller that iteratively applies a range of parameter metrics to synthetic RF environment and IP traffic flow to characterize the performance of a datalink network. A report and model of datalink performance is produced and may be used to mission effectiveness assessments, reliant system testing, AI/ML training, and dynamically select settings for a datalink in real-world conditions. The network modeling system may receive a mission scenario that defines the location, orientation, and speed of a mobile platform over time. The datalink network may then be further characterized according to mission parameters. The network modeling system may produce a database of datalink performance under various scenarios. The database may then be used to train a neural network or other machine learning technology to select settings for a datalink.

### BACKGROUND

Building accurate models of radio datalink networks in complex, real-world environments is challenging in both commercial and military spaces. Modeling how heterogenous datalink networks perform in terms of Internet Protocol (IP) data transfer in the presence of dynamic RF environments, RF interference, and other mission induced effects, and measures is a challenge in the modern connected world and battlespace.

Historically this testing and the resulting models has been limited in complexity due to restricted dimensions of freedom, RF synthetic environment capabilities, the inability to quickly correlate high dimensional detailed network traffic results with high dimensional RF conditions, and radio network performance in the presence of other interference sources. Classic systems have used adjustable attenuators and passing IP network traffic at different signal loss values corresponding to a single RF dimension. This methodology relegates mission specific parameters such as adversarial emitters, platform location, speed, number of platforms, terrain, and the like as fixed assumptions or unaccounted for entirely.

### SUMMARY

In one aspect, embodiments of the inventive concepts disclosed herein are directed to a datalink network modeling system that includes an RF synthetic environment and IP network traffic controllers that iteratively applies a range of parameter metrics to networks of datalink devices to characterizes their performance. A report and model of datalink network performance is produced. Outputs may be used to dynamically select settings for a datalink in real-world conditions, predict datalink network future mission performance, validate performance claims, and train artificial intelligence systems.

In a further aspect, the network modeling system may receive a mission scenario that defines the location, orientation, and speed of mobile platforms over time. The datalink network may then be further characterized according to the specific mission parameters.

In a further aspect, the network modeling system may produce a database of datalink performance under various scenarios. The database may then be used to train a neural network or other machine learning technology to select optimal settings for a datalink. The same information may be used by conventional algorithms to select the optimal settings for a datalink.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a block diagram of a network modeling system according to an exemplary embodiment;

FIG. 2 shows a flowchart of a method according to an exemplary embodiment; and

FIG. 3 shows a flowchart of a method according to an exemplary embodiment.

### DETAILED DESCRIPTION

Before explaining various embodiments of the inventive concepts disclosed herein in detail, it is to be understood that the inventive concepts are not limited in their application to the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of a feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in at least one embodiment” in the specification does not necessarily refer to the same embodiment. Embodiments of the inventive concepts disclosed may include one or more of the features expressly described or inherently present herein, or any combination or sub-combination of two or more such features.

Broadly, embodiments of the inventive concepts disclosed herein are directed to a datalink network modeling system that includes an RF synthetic environment and IP network traffic controllers that iteratively applies a range of parameter metrics to networks of datalink devices to characterize their performance. A report and model of datalink network performance is produced. Outputs may be used to dynamically select settings for a datalink in real-world conditions, predict datalink network future mission performance, validate performance claims, and train artificial intelligence systems. The network modeling system may receive a mission scenario that defines the location, orientation, and speed of mobile platforms over time. The datalink network may then be further characterized according to the specific mission parameters. The network modeling system may produce a database of datalink performance under various scenarios. The database may then be used to train a neural network or other machine learning technology to select optimal settings for a datalink. The same information may be used by conventional algorithms to select the optimal settings for a datalink.

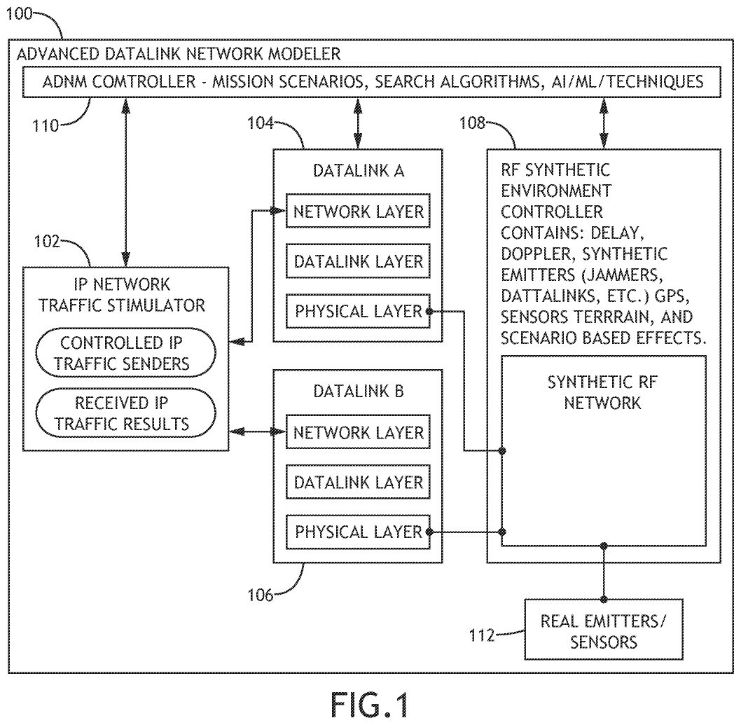

Referring to FIG. 1, a block diagram of a network modeling system 100 according to an exemplary embodiment is shown. Testing has traditionally been done with variable attenuators that alter signal strength and no correlated control of IP network traffic flow. In at least one embodiment, the network modeling system 100 includes an RF synthetic environment controller 108 instead of one or more variable attenuators, and an IP network traffic simulating element 102. By knowing what IP traffic flows are passed in (via the IP network traffic simulating element 102) and the synthetic environment settings (via the RF synthetic environment controller 108), the network modeling system 100 has the information necessary to solve for “Network Layer” through “Physical Layer” performance for each datalink.

The RF synthetic environment controller 108 may be configured to simulate delay, doppler shift, synthetic emitters (e.g., jammers, other datalinks in network, etc.), GPS, sensors, terrain, mission or scenario-based effects, or the like. In at least one embodiment, the RF synthetic environment controller 108 may utilize real emitters and sensors 112 during simulations. Emitters may include jammers, synthetic sensors, or the like, to determine if a sensor was tripped to alert anti-aircraft assets.

In at least one embodiment, real datalink devices being characterized 104, 106 may be in data communication and/or electronic communication with the RF synthetic environment controller 108. The RF synthetic environment controller 108 may iteratively simulate data transmission between the datalink devices 104, 106 at various distances. In at least one embodiment, the RF synthetic environment controller 108 may perform either a parameter-based search that classifies the datalinks according to their respective performance under various conditions. Alternatively, or in addition, the RF synthetic environment controller 108 may simulate a mission of some kind, if the parameters and conditions are known ahead of time, and characterize how the datalink network would perform over that mission. Missions may be defined by known locations of a platform (including pitch, roll, and yaw, and potentially environmental and geographic parameters that are likely to be encountered).

In at least one embodiment, the IP network traffic simulating element 102 is in data communication with the datalink devices 104, 106 to stimulate specific IP network flows on the datalink devices 104, 106 during known Synthetic RF Network 108 values. Synthetic datalinks including synthetic friendly emitters and swarms of radios intercommunicating (e.g., self-driving cars, and the like) may produce a cluttered environment for the datalink devices 104, 106 that may be degraded in performance. In order to be on the same frequency as multiple other datalinks and sharing a network, devices have to share resources which may not be modeled traditionally, impacts include effects such as highly variable latency, packet loss, out of order reception, and data rate drops. IP network flows may be defined by such parameters as packet size, data rates, or the like.

In at least one embodiment, the network modeling system 100 may include a controller 110 in data communication with the datalink devices 104, 106, the RF synthetic environment controller 108, and the IP traffic simulating element 102. The controller 110 may receive and apply mission scenarios, search algorithms, machine learning techniques, configure datalinks under test, or the like. It may be appreciated that the connection between the controller 110 and the datalink devices 104, 106 is for configuration of the datalink devices 104, 106 under test. The connection between the IP network simulating element 102 and the datalink devices 104, 106 is for sending network traffic flows to characterize performance. Control in timing, packet size, and TX/RX time must be tightly known to get accurate performance.

Previously, only one-dimensional testing was possible with the adjustment of variable attenuators. Embodiments of the present disclosure enable multi-dimensional testing and classification, automatically and simultaneously. The network modeling system 100 may produce a report or model of network response to various scenarios or parameters. Such model may be applied by an avionics system to select datalink parameters during a mission, predict avionics software impacts, and validate network resilience in adverse conditions.

In at least one embodiment the report or model may be generally directed toward identifying when datalinks are broken. For example, extending RF pathloss until a datalink breaks for small internet traffic; then the network modeling system 100 could utilize the same parameter, passing large pieces of internet traffic to identify where the datalink breaks. The resulting model would then treat the packets differently based on the size and report the limits of each. The network modeling system may then perform dynamic searching on different traffic types in other RF conditions.

In at least one embodiment, the models generated may be used to train a neural network or other machine learning technology. Models may be generated based on a broad spectrum of scenarios and parameters to produce a database of datalink network models suitable for training artificial intelligence systems. Many platforms with multiple independent datalink networks can then be modeled for multi-AI agent system training.

In at least one embodiment, the network modeling system 100 may operate in a performance characterization mode where performance limits of datalink devices 104, 106 under test are tested over various inputs and RF conditions. The result is a model and a detailed report of these behaviors and performance limits of the datalink. Alternatively, or in addition, the network modeling system 100 may operate in a mission evaluation mode where average performance over a set mission described in network flows and platform movements in a RF Synthetic Environment 108. The result of this is a model and performance report of the expected behavior during the mission.

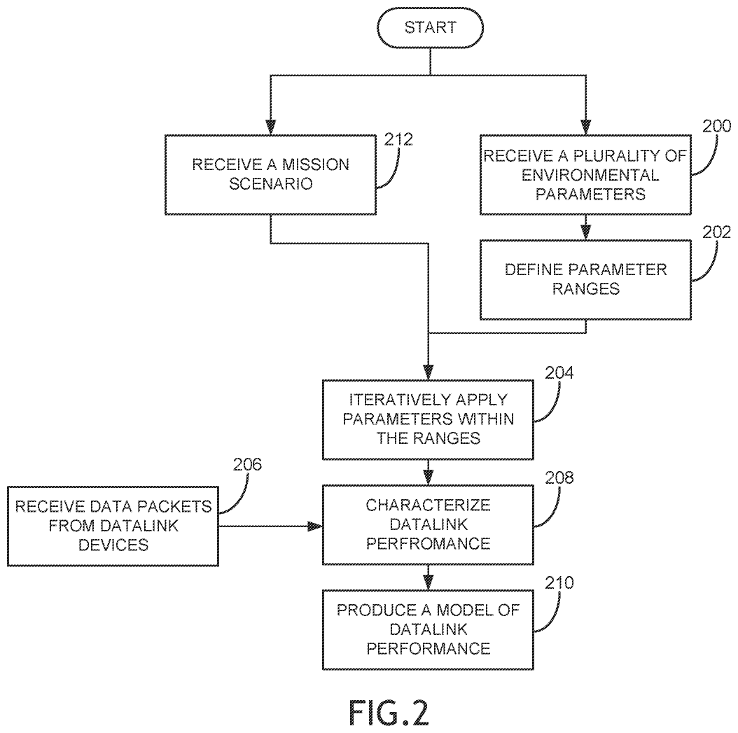

Referring to FIG. 2, a flowchart of a method according to an exemplary embodiment is shown. A network modeling system receives 200 a plurality of environmental parameters to apply to a datalink connection between datalink devices under test, and defines 202 test ranges for those parameters. Such test range may be based on known environmental conditions, maximum/minimum operating conditions, or the like. The network modeling system iteratively applies 204 the parameters then receives 206 data packets from one or more datalink devices under test, and measures various metrics to characterize 208 datalink performance according to tested parameters.

In at least one embodiment, the network modeling system may receive 212 mission parameters/scenarios. Such parameters may include the speed, location, and orientation of virtual mobile platforms associated with the datalink devices, expected virtual emitters/jammers, or the like.

In at least one embodiment, tests may include throughput metrics such as network throughput over distance (RF attenuation), throughput while partially interfered, based on position/formation of RF network nodes, based on number of RF network nodes, doppler shift, based on antenna(s) positioning, and an average based on mission conditions. Metrics may also include IP flow characteristics including multicast, TCP/UDP, packet size, and routing behaviors in different node visibility scenarios including unknown address behaviors. Metrics of IP latency may include average latency over the mission scenario and latency jitter. Metrics of IP message loss rate may include measured packet error rate over the mission scenario, packet error rate in the presence of weather or temporal conditions, packet error rate in the presence of RF interference, and Media Access Control (MAC) and Physical (PHY) layer impacts. Metrics of IP message re-ordering may include datalink re-ordering of messages under stress. Metrics of RF receiver sensitivity may include planned antenna employment, orientation, platform blockage, mission performance, IP packet loss to attenuation, IP packet loss to doppler shift, bit error rate to packet error rate, and jamming sensitivity.

The network modeling system may characterize 208 datalinks according to low probability of intercept metrics measuring RF power over controlled traffic flows and discovery periods. Likewise, system may characterize 208 datalinks according to low probability of detect as measured by RF behaviors in presence of jamming, RF behavior in increased traffic flow, RF behavior with unknown destination or broadcast messages, and RF energy received at synthetic adversarial sensors.

In at least one embodiment, the network modeling system may characterize 208 datalinks according to mission aware measures: did adversary sensors receive RF energy when transmitting unicast, receive RF energy when transmitting multicast, receive RF energy during reconnection phases, or RF energy sending to unknown IP addresses?

Once datalink performance is characterized 208, the network modeling system produces 210 a report and/or model of datalink performance. Multiple reports and models may be produced over time and under a variety of conditions to produce a database of performance metrics that may be used to train a neural network.

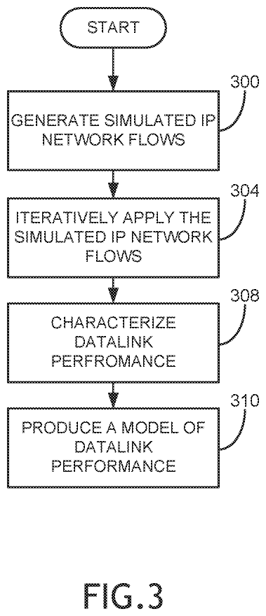

Referring to FIG. 3, a flowchart of a method according to an exemplary embodiment is shown. A network modeling system generates 300 simulated IP network flows and iteratively applies 304 those simulated IP network flows to datalink devices under test. The simulated IP network flows may be applied under a plurality of simulated environmental conditions to characterize 308 datalink performance between the devices under test. Based on the performance, and the characteristics of the known IP network flows, the network modeling system may produce 310 a model of datalink performance. Such models may be useful for making decisions when selecting communication devices or communication settings, or for training AI/ML models.

A network connectivity modeling system includes a controller that simulates parameters in an RF and IP network, and iterates through them with connected data link devices to produce a report of network connectivity and how the network performed under those parameters and potentially how intercepting devices might have performed in that environment.

It is believed that the inventive concepts disclosed herein and many of their attendant advantages will be understood by the foregoing description of embodiments of the inventive concepts, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The forms herein before described being merely explanatory embodiments thereof, it is the intention of the following claims to encompass and include such changes. Furthermore, any of the features disclosed in relation to any of the individual embodiments may be incorporated into any other embodiment.

What is claimed is:

1. A computing apparatus comprising:
at least one processor in data communication with a memory storing processor executable code for configuring the at least one processor to:
receive a plurality of network parameters;
establish datalink connections between at least two devices under test;
iteratively apply various conditions to data transfers between the at least two devices according to the plurality of network parameters; and
produce a report of one or more data transfer metrics measured while iteratively applying the various conditions.

2. The computing apparatus of claim 1, wherein the at least one processor is further configured to produce a model of datalink behavior as defined by the plurality of network flow and RF synthetic environment parameters.

3. The computing apparatus of claim 1, wherein:
the at least one processor is further configured to receive at least one mission scenario; and
iteratively applying various conditions to the data transfers includes applying the at least one mission scenario.

4. The computing apparatus of claim 1, wherein the at least one processor is further configured to emulate one or more IP network traffic events while iteratively applying various conditions to the data transfers and RF synthetic environment.

5. The computing apparatus of claim 1, wherein the at least one processor is further configured to receive RF signals from one or more real emitters in data communication with the at least one processor, providing a synthetic environment.

6. The computing apparatus of claim 1, wherein the at least one processor is further configured to determine if adversarial synthetic sensors emulated by the at least one processor detected a data transfer while iteratively applying various conditions to the data transfers and RF environment.

7. The computing apparatus of claim 1, wherein the plurality of network parameters comprises at least one environmental parameter, and at least one network traffic parameter.

8. A method comprising:
receiving a plurality of network parameters;
establishing datalink connections between at least two devices under test;
generating one or more simulated IP network flows;
iteratively applying various conditions to the one or more simulated IP network flows between the at least two devices according to the plurality of network parameters; and
producing a report of one or more data transfer metrics measured while iteratively applying the various conditions.

9. The method of claim 8, further comprising producing a model of datalink behavior as defined by the plurality of network parameters.

10. The method of claim 8, further comprising receiving at least one mission scenario, wherein iteratively applying various conditions to the data transfers includes applying the at least one mission scenario.

11. The method of claim 8, further comprising receiving signals from one or more real emitters in data communication with the at least one processor.

12. The method of claim 8, further comprising determining if a sensor in data communication with the at least one processor detected a data transfer while iteratively applying various conditions to the data transfers.

13. The method of claim 8, wherein the plurality of network parameters comprises at least one environmental parameter, and at least one network traffic parameter.

14. A network modeling system comprising:
at least one processor in data communication with a memory storing processor executable code for configuring the at least one processor to:
receive a plurality of network parameters;
establish datalink connections at least two devices to test;
generate one or more simulated IP network flows including the at least two devices; and
produce a report of one or more data transfer metrics measured while generating the one or more simulated data flows.

15. The network modeling system of claim 14, wherein the at least one processor is further configured to iteratively apply various conditions to the one or more data flows according to the plurality of network parameters.

16. The network modeling system of claim 15, wherein the at least one processor is further configured to produce a model of datalink behavior as defined by the plurality of network flow and RF synthetic environment parameters.

17. The network modeling system of claim 15, wherein:
the at least one processor is further configured to receive at least one mission scenario; and
iteratively applying various conditions to the data transfers includes applying the at least one mission scenario.

18. The network modeling system of claim 15, wherein the at least one processor is further configured to receive RF signals from one or more real emitters in data communication with the at least one processor, providing a synthetic environment.

19. The network modeling system of claim 15, wherein the at least one processor is further configured to determine if adversarial synthetic sensors emulated by the at least one processor detected a data transfer while iteratively applying various conditions to the data transfers and RF environment.

20. The network modeling system of claim 15, wherein the plurality of network parameters comprises at least one environmental parameter, and at least one network traffic parameter.
